(19) United States
(12) Patent Application Publication
(10) Pub. No.: US 2019/0010333 A1
(43) Pub. Date: Jan. 10, 2019

(54) COARSE CALCINED KAOLIN AND USES THEREOF

(71) Applicant: BASF Corporation, Florham Park, NJ (US)

(72) Inventors: Wilson Wanene Kamau, Warner Robins, GA (US); Ashok Khokhani, Manalapan, NJ (US); Robert Shane Porzio, Charlotte, NC (US); Nicholas Foley, Charlotte, NC (US); William Joseph Rosano, Waxhaw, NC (US)

(21) Appl. No.: 16/028,987

(22) Filed: Jul. 6, 2018

Related U.S. Application Data
(60) Provisional application No. 62/529,800, filed on Jul. 7, 2017.

(51) Int. Cl. C09C 1/42; C09D 7/40; C09D 133/04

(52) U.S. Cl. CPC C09C 1/42; C09D 7/69; C09D 133/04; C01P 2004/61; C01P 2002/72; C01P 2004/53; C01P 2006/19; C01P 2006/12; C01P 2004/03; C01P 2006/60

(57) ABSTRACT

Kaolin compositions comprising coarse kaolin particles are disclosed herein. The kaolin compositions can include kaolin particles having a GE brightness of at least 78 and a particle size distribution wherein at least 50% by weight of the kaolin particles have an equivalent size diameter (e.s.d.) of 30 μm or greater. In some embodiments, the kaolin compositions can include kaolin particles having a bimodal particle distribution. In other embodiments, the kaolin compositions can include kaolin particles having a low crystalline silica content, such as a crystalline silica content of 0.1% by weight or less and a particle size distribution wherein at least 50% by weight of the kaolin particles have an equivalent size diameter (e.s.d.) of 15 μm or greater. In some embodiments, the kaolin particles can be free of crystalline silica. Methods of making and using the kaolin compositions are also disclosed herein.

### CROSS-REFERENCE TO RELATED APPLICATIONS

This application claims the benefit of and priority to U.S. Patent Application No. 62/529,800 filed on Jul. 7, 2017, the disclosure of which is expressly incorporated herein by reference in its entirety.

### FIELD OF THE DISCLOSURE

This disclosure relates generally to coarse kaolin pigments for use in coatings with improved texture.

### BACKGROUND OF THE DISCLOSURE

Kaolin has many uses due to its favorable properties such as natural whiteness, fine particle size, non-abrasiveness, and chemical stability. Kaolin deposits, however, are sedimentary and is therefore frequently contaminated with impurities that detracts from its brightness and value. For this and other reasons, much attention and research in the kaolin industry has focused on refining kaolins and removing the major impurities.

Two basically different processes are used to refine and purify kaolin. The simplest process is called air flotation or the dry process. In this process, the properties of the finished product depend to a large extent on those properties inherent in the crude kaolin. The second process used to produce kaolins is much more complex and is called the wet process. In this process, crude kaolin is generally slurried, degritted, fractionated to the desired particle size and the resulting fractions bleached to improve both brightness and shade. Other processing methods can be employed, such as selective sedimentation, magnetic separation, froth flotation, and selective flocculation to improve the brightness of the kaolin products. These methods can be employed to produce both standard and high brightness products from highly discolored starting materials by removing much of the iron stained titanium and ferriferous material.

The kaolin purification processes produce a substantial amount of rejected material which have heretofore been discarded. A need exists for processes for producing a usable kaolin material from the rejected material during the above processes or a similar process which produces kaolin rejects. The materials and methods disclosed herein address these and other needs.

### SUMMARY OF THE DISCLOSURE

Kaolin compositions comprising coarse kaolin particles are disclosed herein. In some embodiments, the kaolin compositions can include kaolin particles having a GE brightness of at least 78 and a particle size distribution wherein at least 50% by weight of the kaolin particles have an equivalent size diameter (e.s.d.) of 30 μm or greater, as determined by a Microtrac Model S3500 Particle Size Analyzer. In other embodiments, the kaolin compositions can include kaolin particles having a bimodal particle distribution. In still other embodiments, the kaolin compositions can include kaolin particles having a low crystalline silica content, such as a crystalline silica content of 0.1% by weight or less and a particle size distribution wherein at least 50% by weight of the kaolin particles have an equivalent size diameter (e.s.d.) of 15 μm or greater, as determined by a Microtrac Model S3500 Particle Size Analyzer. In some embodiments, the kaolin particles can be free of crystalline silica.

As described herein, the GE brightness of the kaolin particles can be 78 or greater, such as 79 or greater, 80 or greater, or 82 or greater. In some embodiments, the GE brightness of the kaolin particles can be from 78 to 89 or from 78 to 86.

The coarse kaolin particles in the kaolin compositions can have a particle size distribution wherein at least 50% by weight of the kaolin particles have an e.s.d. of 15 μm or greater or 30 μm or greater. For example, at least 50% by weight of the kaolin particles can have an e.s.d. from 15 μm to 200 μm or from 30 μm to 200 μm. In some embodiments, at least 90% by weight of the kaolin particles have an e.s.d. of 75 μm or less. In some embodiments, at least 20% by weight of the kaolin particles have an e.s.d. of less than 15 μm. The kaolin compositions can have a +325 mesh content of 21% by weight or greater.

As described herein, the kaolin composition can have a bimodal particle distribution. When the composition is bimodal, the composition can include a first fraction having an average particle diameter of from 3 μm to 8 μm and a second fraction having an average particle diameter of from 30 μm to 50 μm. The weight ratio between the first fraction and the second fraction can be from 1:4 to 2:1 or from 1:2 to 1:1.

The kaolin particles disclosed herein can have a low oil absorption. For example, the kaolin particles can exhibit an oil absorption of less than 30 pounds such as 25 pounds or less of oil per 100 pounds of kaolin (lbs oil/100 lbs kaolin). In some embodiments, the oil absorption of the kaolin particles can be from 17 to 25 lbs oil/100 lbs kaolin.

The surface area of the kaolin particles can be 10 m²/g or less. In some embodiments, the average surface area of the kaolin particles can be from 5 to 10 m²/g. The kaolin particles can have a tap bulk density of 80 pcf or greater.

The kaolin particles can be heat treated. For example, the kaolin compositions can comprise calcined kaolin particles. The calcined kaolin particles can include a mullite phase having a mullite index of 25 or greater. In some embodiments, the mullite index of the kaolin particles can be from 35 to 62.

The kaolin particles disclosed herein can include a super hard material content. For example, a +400 mesh fraction of the kaolin particles can have an attrition rate of less than 3% (e.g., less than 2%), as determined by ASTM D5757.

Coatings comprising the kaolin compositions are also disclosed herein. Coatings prepared from the kaolin compositions can have a scrub resistance of at least 3000 cycles, as determined by ASTM D2486-06. For example, the coatings can have a scrub resistance of from 3000 to 4500 cycles, as determined by ASTM D2486-06. In some embodiments, the coatings can be a slip-resistant coating and can be formulated as, for example, a paint.

Articles comprising the kaolin compositions are also disclosed herein. Articles comprising the kaolin compositions can include a tile or a paper.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 is a bar graph showing the particle size distribution of coarse kaolin, as described herein.

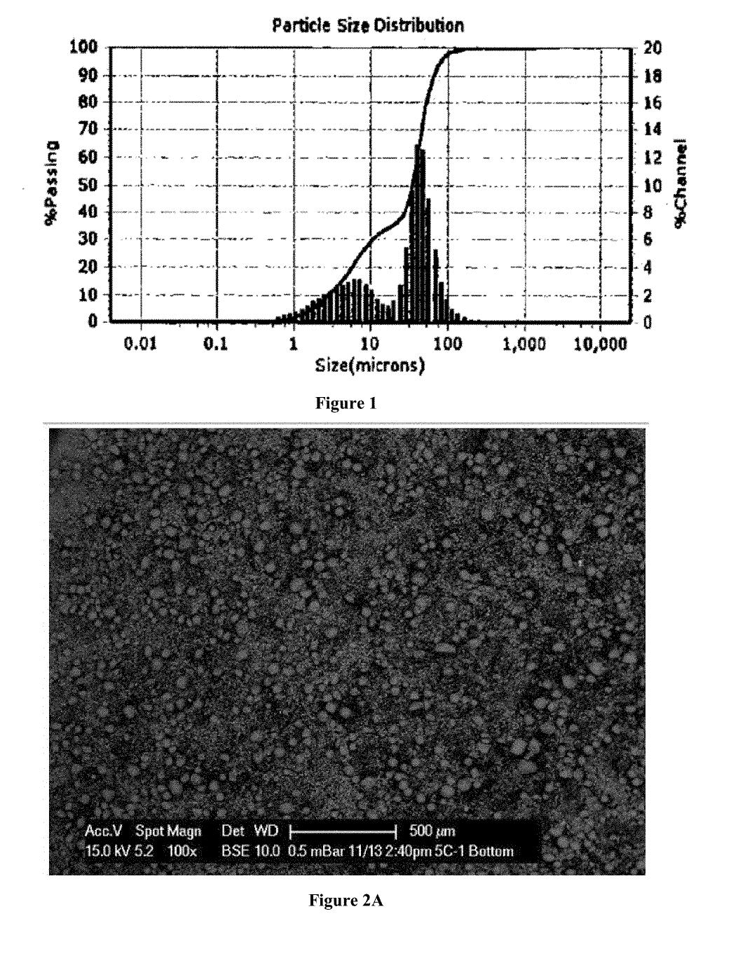

FIGS. 2A and 2B are scanning electron microscope (SEM) images showing a coarse kaolin composition.

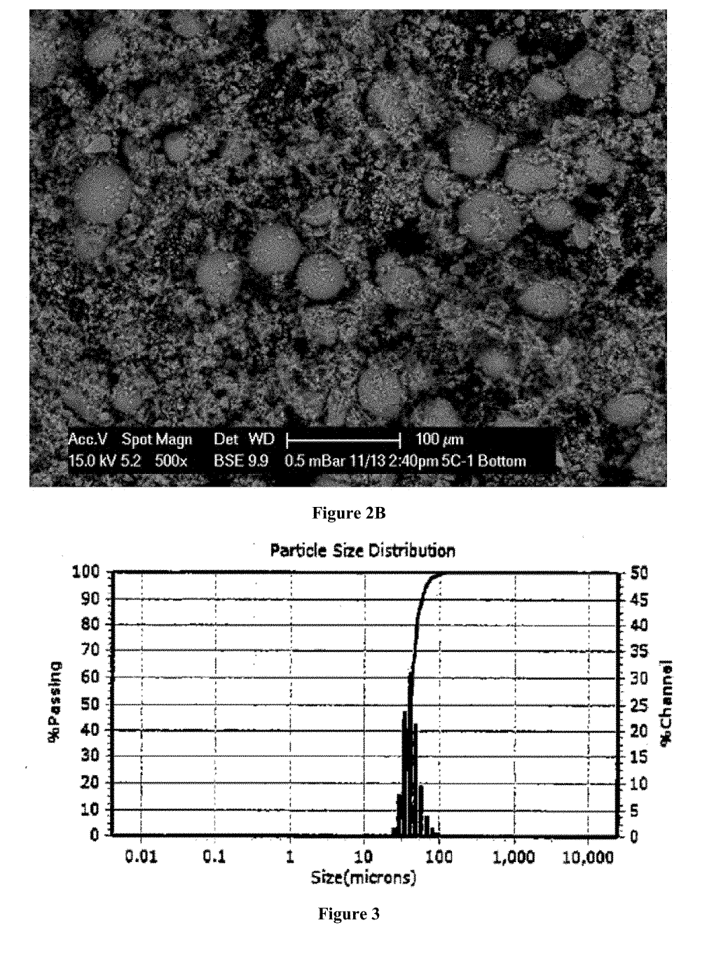

FIG. 3 is a bar graph showing the particle size distribution of the +400 mesh fraction of a coarse kaolin sample.

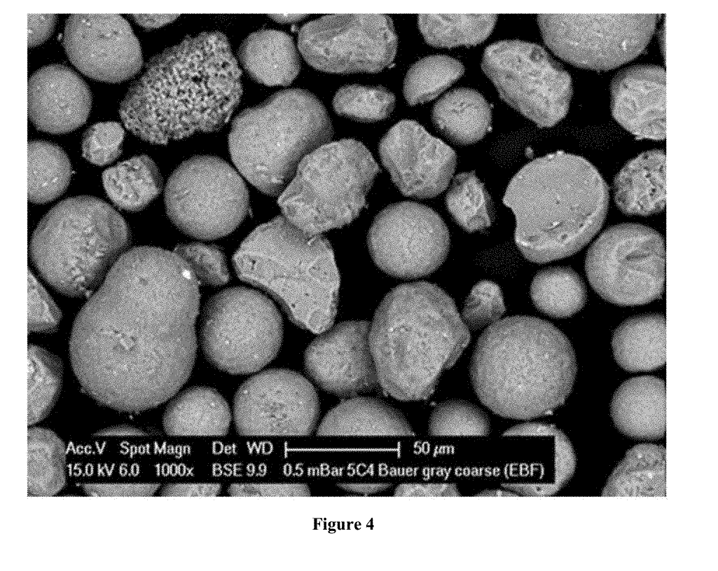

FIG. 4 is a SEM image showing the +400 mesh fraction of a coarse kaolin sample.

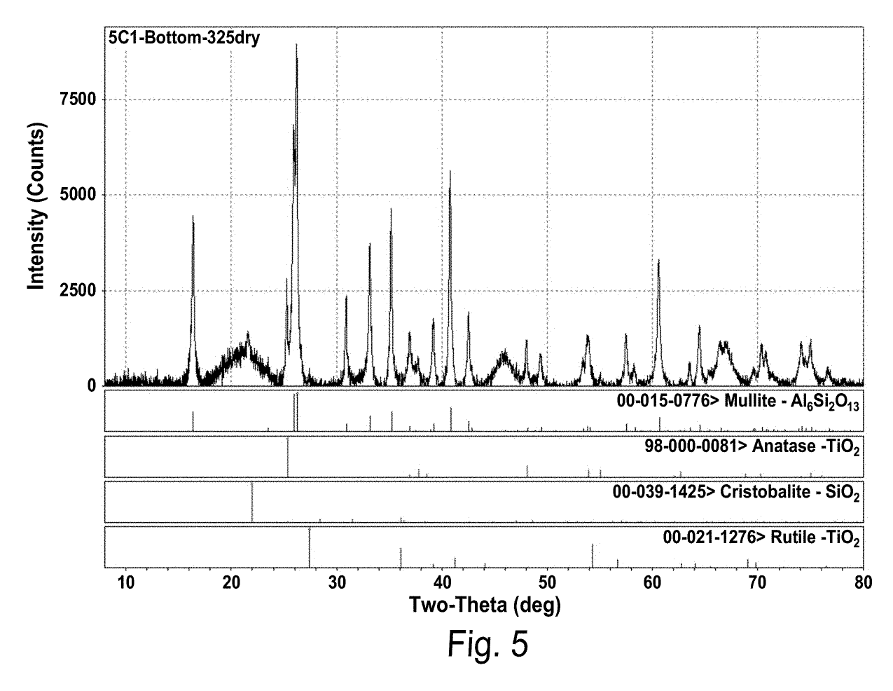

FIG. 5 is an X-ray diffraction (XRD) scan of a coarse kaolin sample.

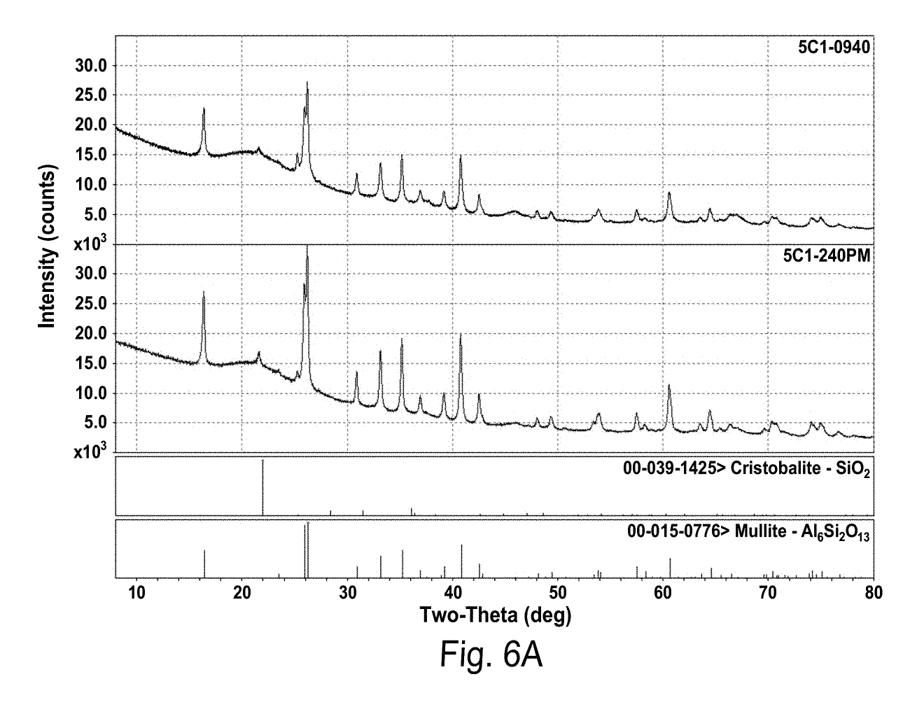

FIGS. 6A and 6B are XRD scans of coarse kaolin samples.

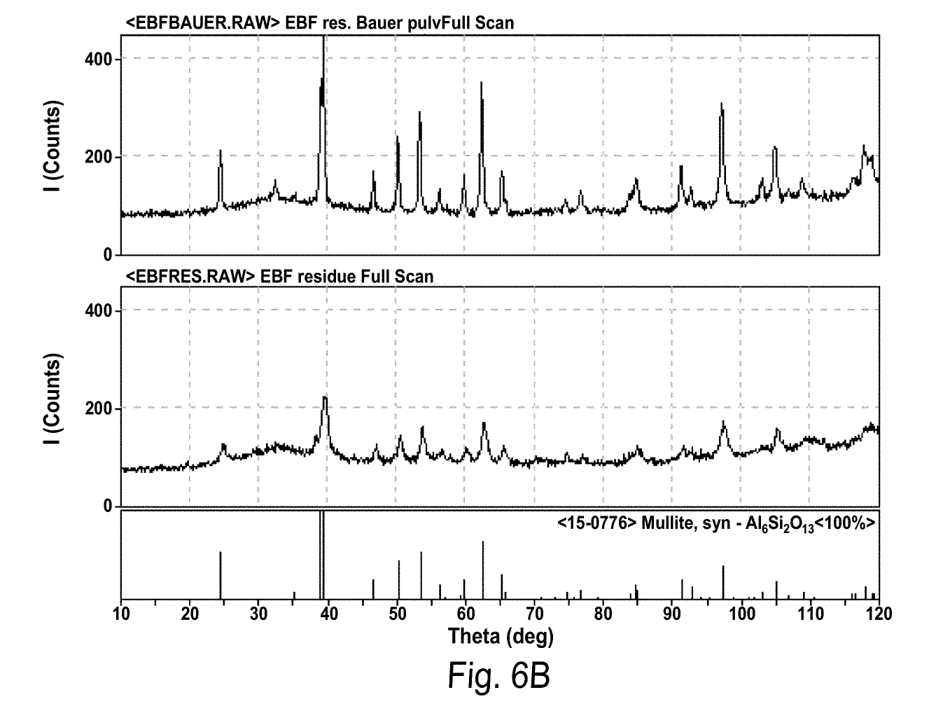

### DETAILED DESCRIPTION

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise. The disclosure of percentage ranges and other ranges herein includes the disclosure of the endpoints of the range and any integers provided in the range.

Disclosed herein are compositions comprising coarse kaolin particles. As described herein, the coarse kaolin particles can be produced from a rejected waste stream kaolin. For example, useful particles are generally produced from kaolin clay by first dispersing the clay in a convenient manner well known in the art and then separating the dispersion into a high brightness, low yellow index fraction and a low brightness high yellow index fraction. This separation may be done by separation methods discussed herein, such as selective sedimentation, selective flocculation (DFA), magnetic separation or froth flotation, either alone or in combination. Heretofore, only the higher brightness, lower yellow material was subjected to further processing to a final product and the lower brightness fractions were either reprocessed for further extraction of high brightness material or, if no more high brightness material can be extracted, discarded. In some aspects, the present disclosure is directed to producing useful kaolin particles from a rejected waste stream during kaolin processing.

The kaolin particles disclosed herein can have a coarse or granular particle size distribution. Particle size distribution (PSD) as used herein can be determined with the SEDIGRAPH 5100 particle size analyzer (Micromeritics Corporation) or a Microtrac Model S3500 Particle Size Analyzer on a kaolin particle in a fully dispersed condition in a standard aqueous medium, such as water. The data are reported as equivalent spherical diameters (e.s.d.) on a weight percentage basis. The median particle size d50 is the value determined in this way of the particle e.s.d. at which there are 50% by weight of the particles that have an e.s.d. less than or equal to the d50 value and 50% by weight of the particles that have an e.s.d. greater than or equal to the d50 value.

In some embodiments, the kaolin particles can have a particle size distribution wherein at least 50% (such as at least 55%, at least 60%, at least 65%, at least 70%, at least 75%, or at least 80%) by weight of the kaolin particles have an e.s.d. of 15 μm or greater, 17 μm or greater, 20 μm or greater, 22 μm or greater, 25 μm or greater, 27 μm or greater, 30 μm or greater, 32 μm or greater, 34 μm or greater, 35 μm or greater, 37 μm or greater, 40 μm or greater, 42 μm or greater, 45 μm or greater, 50 μm or greater, 55 μm or greater, 60 μm or greater, or 65 μm or greater, as determined by a Microtrac Model S3500 Particle Size Analyzer. In some embodiments, at least 50% (such as at least 55%, at least 60%, at least 65%, at least 70%, at least 75%, or at least 80%) by weight of the kaolin particles can have an e.s.d. of 75 μm or less, 70 μm or less, 65 μm or less, 60 μm or less, 55 μm or less, 50 μm or less, 45 μm or less, 40 μm or less, 35 μm or less, 30 μm or less, 25 μm or less, or 20 μm or less, as determined by a Microtrac Model S3500 Particle Size Analyzer. In some embodiments, at least 50% (at least 55%, at least 60%, at least 65%, at least 70%, or at least 75%) by weight of the kaolin particles have an e.s.d. of from 15 μm to 200 μm, from 20 μm to 200 μm, from 25 μm to 200 μm, from 30 μm to 200 μm, from 32 μm to 200 μm, from 15 μm to 150 μm, from 20 μm to 150 μm, from 25 μm to 150 μm, from 32 μm to 150 μm, from 35 μm to 150 μm, from 15 μm to 100 μm, from 20 μm to 100 μm, from 25 μm to 100 μm, from 30 μm to 100 μm, from 32 μm to 100 μm, from 15 μm to 80 μm, from 20 μm to 80 μm, from 25 μm to 80 μm, from 30 μm to 80 μm, from 32 μm to 80 μm, from 40 μm to 80 μm, or from 40 μm to 60 μm, as determined by a Microtrac Model S3500 Particle Size Analyzer.

The kaolin particles disclosed herein can have a particle size distribution wherein at least 20% by weight of the kaolin particles have an e.s.d. of 25 μm or less, 20 μm or less, 18 μm or less, 15 μm or less, 12 μm or less, 10 μm or less, 8 μm or less, or 5 μm or less, as determined by a Microtrac Model S3500 Particle Size Analyzer. In some embodiments, at least 20% by weight of the kaolin particles can have a particle size of 5 μm or greater, 6 μm or greater, 7 μm or greater, 8 μm or greater, 9 μm or greater, 10 μm or greater, 11 μm or greater, 12 μm or greater, 15 μm or greater, 18 μm or greater, or 20 μm or greater, as determined by a Microtrac Model S3500 Particle Size Analyzer. In some embodiments, at least 20% by weight of the kaolin particles can have an e.s.d. of from 0.1 μm to 15 μm, from 0.5 μm to 15 μm, from 1 μm to 15 μm, from 1 μm to 10 μm, or from 1 μm to 8 μm, as determined by a Microtrac Model S3500 Particle Size Analyzer.

The kaolin particles disclosed herein can have a particle size (d90) wherein 90% by weight of the particles have an e.s.d. less than or equal to the d90 value and 10% by weight of the particles have an e.s.d. greater than or equal to the d90 value. In some embodiments, the kaolin particles can have a d90 particle size of 50 μm or greater, 55 μm or greater, 57 μm or greater, 60 μm or greater, 62 μm or greater, 64 μm or greater, 65 μm or greater, 67 μm or greater, 70 μm or greater, 72 μm or greater, 75 μm or greater, 80 μm or greater, 85 μm or greater, 90 μm or greater, 95 μm or greater, or up to 100 μm, as determined by a Microtrac Model S3500 Particle Size Analyzer. In some embodiments, the kaolin particles can have a d90 particle size of about 100 μm or less, 95 μm or less, 90 μm or less, 85 μm or less, 80 μm or less, 77 μm or less, 75 μm or less, 72 μm or less, 70 μm or less, 68 μm or less, 65 μm or less, 63 μm or less, 60 μm or less, 57 μm or less, 55 μm or less, or 50 μm or less, as determined by a Microtrac Model S3500 Particle Size Analyzer. In some embodiments, the kaolin particles can have a d90 particle size of from 50 μm to 100 μm, from 50 μm to 95 μm, from 50 μm to 80 μm, from 55 μm to 95 μm, from 55 μm to 85 μm, from 55 μm to 75 μm, from 57 μm to 70 μm, from 60 μm to 90 μm, from 60 μm to 85 μm, or from 60 μm to 75 μm, as determined by a Microtrac Model S3500 Particle Size Analyzer.

The kaolin particles disclosed herein can have a particle size (d10) wherein 10% by weight of the particles have an e.s.d. less than or equal to the d10 value and 90% by weight of the particles have an e.s.d. greater than or equal to the d10 value . . . . For example, the kaolin particles can have a d10 particle size of 1.0 μm or greater, 1.5 μm or greater, 2.0 μm or greater, 2.5 μm or greater, 3.0 μm or greater, 3.5 μm or greater, 4.0 μm or greater, 4.5 μm or greater, 5.0 μm or greater, 5.5 μm or greater, or 6.0 μm or greater, as determined by a Microtrac Model S3500 Particle Size Analyzer. In some embodiments, the kaolin particles can have a d10 particle size of 7.0 μm or less, 6.5 μm or less, 6.0 μm or less, 5.5 μm or less, 5.0 μm or less, 4.5 μm or less, 4.0 μm or less, 3.5 μm or less, 3.0 μm or less, 2.5 μm or less, 2.0 μm or less, 1.5 μm or less, or 1.0 μm or less, as determined by a Microtrac Model S3500 Particle Size Analyzer. In some embodiments, the kaolin particles can have a d10 particle size of from 1.0 μm to 7.0 μm, from 1.0 μm to 6.0 μm, from 1.5 μm to 5.5 μm, from 1.5 μm to 5.0 μm, from 1.5 μm to 4.0 μm, from 2.0 μm to 5.0 μm, from 2.0 μm to 4.5 μm, from 2.0 μm to 4.0 μm, from 2.0 μm to 3.5 μm, or from 2.0 μm to 3.0 μm, as determined by a Microtrac Model S3500 Particle Size Analyzer.

Representative ranges for PSD and mean particle size for the kaolin particles disclosed herein are provided in Table 1. PSD and mean particle size for representative kaolin particles are provided in Table 2.

TABLE 1

Ranges

| | | | | |
|---|---|---|---|---|
| d90 μm | ≤100 | 50-100 | 50-90 | 60-80 |
| d50 μm | ≤55 | 15-55 | 20-50 | 30-45 |
| d10 μm | ≤10 | 0.5-10 | 1.0-8.0 | 2.0-5.0 |

TABLE 2

| | Representative kaolins | | |
|---|---|---|---|
| | A | B | C |
| d90 μm | 70 | 65 | 60 |
| d50 μm | 40 | 35 | 30 |
| d10 μm | 3.0 | 2.8 | 2.5 |

In some embodiments, the kaolin compositions can have a bimodal particle distribution. “Bimodal” as used herein refers to the presence of at least two distinct particle size peaks in the particle size distribution for the overall kaolin composition. When the kaolin compositions are bimodal, the composition can include a first kaolin particle fraction having an average particle diameter of 10 μm or less. For example, the first fraction can have an average particle diameter of 9.0 μm or less, 8.0 μm or less, 7.0 μm or less, 6.5 μm or less, 6.0 μm or less, 5.5 μm or less, 5.0 μm or less, 4.5 μm or less, 4.0 μm or less, 3.5 μm or less, 3.0 μm or less, 2.5 μm or less, 2.0 μm or less, 1.5 μm or less, or 1.0 μm or less, as determined by a Microtrac Model S3500 Particle Size Analyzer. In some embodiments, the first fraction can have an average particle diameter of 1.0 μm or greater, 1.5 μm or greater, 2.0 μm or greater, 2.5 μm or greater, 3.0 μm or greater, 3.5 μm or greater, 4.0 μm or greater, 4.5 μm or greater, 5.0 μm or greater, 5.5 μm or greater, or 6.0 μm or greater, as determined by a Microtrac Model S3500 Particle Size Analyzer. In some embodiments, the first fraction can have an average particle diameter of from 1.0 μm to 10 μm, from 1.0 μm to 7.0 μm, from 1.0 μm to 6.0 μm, from 1.5 μm to 5.5 μm, from 1.5 μm to 5.0 μm, from 1.5 μm to 4.0 μm, from 2.0 μm to 5.0 μm, from 2.0 μm to 4.5 μm, from 2.0 μm to 4.0 μm, from 2.0 μm to 3.5 μm, or from 2.0 μm to 3.0 μm, as determined by a Microtrac Model S3500 Particle Size Analyzer.

The bimodal composition can comprise a second kaolin particle fraction having an average particle diameter of 55 μm or less. For example, the second fraction can have an average particle diameter of 50 μm or less, 48 μm or less, 45 μm or less, 43 μm or less, 40 μm or less, 38 μm or less, 35 μm or less, or 33 μm or less, as determined by a Microtrac Model S3500 Particle Size Analyzer. In some embodiments, the second fraction can have an average particle diameter of 25 μm or greater, 30 μm or greater, 32 μm or greater, 33 μm or greater, 35 μm or greater, 36 μm or greater, 38 μm or greater, 40 μm or greater, 42 μm or greater, 45 μm or greater, or up to 50 μm, as determined by a Microtrac Model S3500 Particle Size Analyzer. In some embodiments, the second fraction can have an average particle diameter of from 25 μm to 55 μm, from 30 μm to 50 μm, from 32 μm to 48 μm, from 32 μm to 45 μm, or from 35 μm to 45 μm, as determined by a Microtrac Model S3500 Particle Size Analyzer.

Where the kaolin compositions are bimodal, the weight ratio between the first fraction and the second fraction can vary. The precise selection of the weight ratio of the first and second fractions in the bimodal composition will depend on the composition sought in the final product, and the desired properties of the final product (e.g., improved scrub resistance, improved hardness, improved attrition resistance, etc.). A person skilled in the art would know, without undue experimentation, the ratio of the first fraction to second fraction needed depending on the properties desired in the final product.

In some embodiments, the weight ratio between the first fraction and the second fraction can be from 1:4 to 2:1. For example, the weight ratio between the first fraction and the second fraction can be 1:4 or greater, 1:3 or greater, 1:2 or greater, 1:1 or greater, 1.5:1 or greater, or 2:1 or greater. In some embodiments, the weight ratio between the first fraction and the second fraction can be 2:1 or less, 1:1 or less, 1:1.5 or less, 1:2 or less, 1:2.5 or less, 1:3 or less, 1:3.5 or less, or 1:4 or less. In some embodiments, the weight ratio between the first fraction and the second fraction can be from 1:4 to 2:1, from 1:3 to 2:1 or from 1:2 to 1:1. In some embodiments, the weight ratio between the first fraction and the second fraction can be in amount to obtain a blend having a median particle size (d50) of from 15 μm to 45 μm.

The kaolin compositions can also be characterized based on their mesh residue content. In some embodiments, the kaolin compositions can have a +325 mesh residue content of 15% or greater, by weight of the kaolin composition. For example, the kaolin compositions can have a +325 mesh residue content of 17% or greater, 18% or greater, 19% or greater, 20% or greater, 21% or greater, 23% or greater, 25% or greater, 26% or greater, or 30% or greater, by weight of the kaolin composition. In some embodiments, the kaolin compositions can have a +325 mesh residue content of 30% or less, 28% or less, 27% or less, 26% or less, 25% or less, 24% or less, 22% or less, or 21% or less, by weight of the kaolin composition. In some embodiments, the kaolin compositions can have a +325 mesh residue content of from 15% to 30%, from 17% to 30%, from 20% to 30%, from 15% to 25%, from 17% to 25%, or from 20% to 25%, by weight of the kaolin composition.

The +400 mesh residue content of the kaolin compositions can be 25% or greater, by weight of the kaolin composition. For example, the kaolin compositions can have a +400 mesh residue content of 27% or greater, 30% or greater, 32% or greater, 35% or greater, 37% or greater, or 40% or greater, by weight of the kaolin composition. In some embodiments, the kaolin compositions can have a +400 mesh residue content of 45% or less, 42% or less, 40% or less, 37% or less, 35% or less, 33% or less, 30% or less, 28% or less, or 25% or less, by weight of the kaolin composition. In some embodiments, the kaolin compositions can have a +400 mesh residue content of from 25% to 45%, from 25% to 40%, from 27% to 40%, from 30% to 40%, from 30% to 38%, or from 30% to 35%, by weight of the kaolin composition.

The kaolin particle disclosed herein can have a GE brightness (GEB) of at least 78%. For example, the kaolin particles can have a brightness of 79% or greater, 80% or greater, 81% or greater, 82% or greater, 83% or greater, 84% or greater, 85% or greater, 86% or greater, 88% or greater, or up to 89%. In some embodiments, the kaolin particles can have a brightness of 89% or less, 88% or less, 87% or less, 86% or less, 85% or less, or 84% or less. In some embodiments, the kaolin particles can have a brightness of from 78% to 89%, from 78% to 88%, from 78% to 87%, from 78% to 86%, from 80% to 89%, from 80% to 88%, or from 80% to 86%. As used herein, brightness is determined by the TAPPI standard method T452. The data are reported as the percentage reflectance to light of a 457 nm wavelength (GEB value).

The kaolin particles can be free or substantially free of crystalline silica. Crystalline silica, also called alpha silica or generally free silica, is silicon dioxide (SiO₂). In pure, natural form, SiO₂ crystals are minute, very hard, translucent, and colorless. Its melting point is 1710° C.; boiling point is 2230° C.; and vapor pressure, 10 mm Hg at 1732° C. Most mined minerals contain some SiO₂. The three most common crystalline forms of silica encountered in industry are: quartz, tridymite, and cristobalite. “Substantially free” as used herein means sufficiently homogeneous to appear free of readily detectable crystalline silica as determined by the NIOSH 7500 method using X-ray diffraction spectroscopy. For example, the kaolin particles can include 0.5% or less, 0.4% or less, 0.3% or less, 0.2% or less, or 0.1% or less by weight of crystalline silica.

The kaolin particles can have a surface area of 10 m²/g or less. For example, the kaolin particle can have a surface area of less than 10 m²/g, 9.5 m²/g or less, 9.0 m²/g or less, 8.5 m²/g or less, 8.0 m²/g or less, 7.5 m²/g or less, 7.0 m²/g or less, 6.5 m²/g or less, or 6.0 m²/g or less. In some embodiments, the kaolin particles can have a surface area of 4.0 m²/g or greater, 5.0 m²/g or greater, 6.0 m²/g or greater, 7.0 m²/g or greater, 8.0 m²/g or greater, or 9.0 m²/g or greater. In some embodiments, the kaolin particles can have a surface area of from 4.0 m²/g to 10 m²/g, from 4.0 m²/g to less than 10 m²/g, from 5.0 m²/g to 9.0 m²/g, or from 4.0 m²/g to 8.0 m²/g.

As used herein, surface area is determined by the art-recognized Brunaruer Emmett Teller (BET) method using N₂ as the adsorbate. In brief, the surface area of a kaolin particles, frozen in liquid nitrogen, is measured by adsorption of nitrogen gas and quantified through BET analysis.

As described herein, the kaolin particles can be derived from the rejected waste of the beneficiation process of a fine kaolin. As such, the kaolin particles can include a significant level of impurities including iron and titanium.

In some embodiments, the kaolin particles can have a Fe₂O₃ content of greater than 0% by weight, based on the total weight of the kaolin particles. In some embodiments, the kaolin particles can have a Fe₂O₃ content of 0.75% by weight or less, 0.5% by weight or less, 0.4% by weight or less, 0.3% by weight or less, or 0.2% by weight or less, based on the total weight of the kaolin particles. In some embodiments, the kaolin particles can have a Fe₂O₃ content of from greater than 0% to 0.75% by weight or from greater than 0% to 0.5% by weight, based on the total weight of the kaolin particles.

The kaolin particles can have a TiO₂ content of greater than 0% by weight, based on the total weight of the kaolin particles. In some embodiments, the kaolin particles can have a TiO₂ content of 2% by weight or less, 1.8% by weight or less, or 1.5% by weight or less, based on the total weight of the kaolin particles. In some embodiments, the kaolin particles can have a TiO₂ content of from greater than 0% to 2% by weight or from greater than 0% to 1.5% by weight, based on the total weight of the kaolin particles. The iron oxide or titanium oxide content of the kaolin particles can be determined by X-ray fluorescence spectroscopy.

The kaolin particles can have an alkali content of greater than 0% by weight or greater. In some embodiments, the kaolin particles can have an alkali content of 0.5% by weight or less, 0.4% by weight or less, 0.3% by weight or less, or 0.2% by weight or less, based on the total weight of the kaolin particles.

The kaolin particles can have a K₂O content of greater than 0% by weight. In some embodiments, the kaolin particles can have an K₂O content of 0.5% by weight or less, 0.4% by weight or less, 0.3% by weight or less, or 0.2% by weight or less, based on the total weight of the kaolin particles.

The kaolin particles can have a Na₂O content of 0% by weight or greater. In some embodiments, the kaolin particles can have an Na₂O content of 0.5% by weight or less, 0.4% by weight or less, 0.3% by weight or less, or 0.2% by weight or less, based on the total weight of the kaolin particles.

The disclosed kaolin particles can have one or more improved properties, increased brightness, reduced yellowness, reduced abrasion loss, low oil absorption, lower residue content, lower crystalline content, and comparable or increased scattering coefficient. Notably, the oil absorption of the kaolin particles disclosed herein is unexpectedly reduced, as compared to current commercial products with similar particle size. As used herein, oil absorption is determined using ASTM D 281 “Oil Absorption by Spatula Rub-out.” The data are reported in pounds (grams) of oil absorbed per 100 pounds (grams) of calcined kaolin (%).

The kaolin particles can have an oil absorption of less than 30% (less than 30 lbs oil per 100 lbs particle) by weight of the kaolin particles. For example, the kaolin particles can have an oil absorption of 29% or less, 28% or less, 27% or less, 26% or less, 25% or less, 24% or less, 22% or less, 20% or less, or 18% or less by weight of the kaolin particles. In some embodiments, the kaolin particles can have an oil absorption of 17% or greater, 18% or greater, 19% or greater, 20% or greater, 22% or greater, 25% or greater, 26% or greater, 27% or greater, 28% or greater, or 29% or greater by weight of the kaolin particles. In some embodiments, the kaolin particles can have an oil absorption of from 17% to less than 30%, from 17% to 29%, from greater than 17% to 25%, from greater 18% to less than 30%, from greater 18% to 28%, or from 20% to 27% by weight of the kaolin particles.

The kaolin particles can comprise a superhard material content. The superhard content of the kaolin particles can be determined by the attrition rate test. The attrition rate data provide information relating to break up of the kaolin particles into fragments. The kaolin particles disclosed herein may exhibit improved attrition resistance. To be considered suitably attrition resistant, a maximum Air Jet Attrition Rate of 3.0 is necessary. In some embodiments, the +400 mesh fraction of the kaolin particles can have an attrition rate of less than 3%, as determined by ASTM D5757. In some embodiments, the +400 mesh fraction of the kaolin particles exhibits an attrition rate of 2% or less, 1.8% or less, 1.6% or less, 1.5% or less, 1.2% or less, 1.0% or less, 0.9% or less, or 0.8% or less by weight, as determined by ASTM D5757.

In some embodiments, the +400 mesh fraction of the kaolin composition comprises at least 35% by weight of the kaolin composition. For example, the 400+ mesh fraction can be 40% or greater, 45% or greater, 50% or greater, 55% or greater, 60% or greater, or 65% or greater, by weight of the kaolin composition. In some embodiments, the +400 mesh fraction can be 70% or less, 65% or less, 60% or less, 55% or less, or 50% or less, by weight of the kaolin composition. The +400 mesh fraction as used herein refers to the kaolin particle fraction having an average particle diameter of greater than 37 μm, such as from greater than 37 μm to 100 μm or from greater than 37 μm to 80 μm, as determined by a Microtrac Model S3500 Particle Size Analyzer.

The kaolin particles disclosed herein can have a tap bulk density of 55 lb/ft³ or greater. In some embodiments, the kaolin particles can have a tap bulk density of 60 lb/ft³ or greater, 65 lb/ft³ or greater, 70 lb/ft³ or greater, 75 lb/ft³ or greater, 80 lb/ft³ or greater, 82 lb/ft³ or greater, or 85 lb/ft³ or greater. In some embodiments, the kaolin particles can have a tap bulk density of 90 lb/ft³ or less, 87 lb/ft³ or less, 85 lb/ft³ or less, 83 lb/ft³ or less, 80 lb/ft³ or less, 75 lb/ft³ or less, or 70 lb/ft³ or less. In some embodiments, the kaolin particles can have a tap bulk density of from 55 lb/ft³ to 90 lb/ft³, from 60 lb/ft³ to 90 lb/ft³, from 65 lb/ft³ to 90 lb/ft³, from 70 lb/ft³ to 90 lb/ft³, from 55 lb/ft³ to 85 lb/ft³, or from 60 lb/ft³ to 85 lb/ft³.

The kaolin particles disclosed herein can have a loose bulk density of 30 lb/ft³ or greater. In some embodiments, the kaolin particles can have a loose bulk density of 35 lb/ft³ or greater, 40 lb/ft³ or greater, 45 lb/ft³ or greater, 47 lb/ft³ or greater, 50 lb/ft³ or greater, 52 lb/ft³ or greater, or 55 lb/ft³ or greater. In some embodiments, the kaolin particles can have a loose bulk density of 60 lb/ft³ or less, 57 lb/ft³ or less, 55 lb/ft³ or less, 53 lb/ft³ or less, 50 lb/ft³ or less, 45 lb/ft³ or less, or 40 lb/ft³ or less. In some embodiments, the kaolin particles can have a loose bulk density of from 30 lb/ft³ to 60 lb/ft³, from 35 lb/ft³ to 60 lb/ft³, from 40 lb/ft³ to 60 lb/ft³, from 30 lb/ft³ to 55 lb/ft³, from 35 lb/ft³ 55 lb/ft³, or from 35 lb/ft³ to 53 lb/ft³.

The kaolin particles can be processed to achieve a product mullite index (M.I.) of 25% or greater. In some embodiments, the particles can be processed to achieve a product M.I. of 30% or greater, 35% or greater, 32% or greater, 35% or greater, 37% or greater, 40% or greater, 45% or greater, 50% or greater, or 55% or greater, 60% or greater, 62% or greater, or 65 or greater. In some embodiments, the particles can be processed to achieve a product M.I. of 65% or less, 62% or less, 60% or less, 55% or less, 50% or less, 45% or less, 40% or less, 35% or less, 30% or less, or 25% or less. In some embodiments, the particles can be processed to achieve a product M.I. of from 25% to 62%, from 30% to 62%, from 35% to 62%, from 40% to 62%, or from 45% to 62%. It is noted that flux addition will affect both of these requirements as well.

Methods of Making

Methods of making the kaolin particles described herein are disclosed. The kaolin particles can be obtained from a waste stream in the process of producing high brightness and/or fine kaolin particles. For example, high brightness and/or fine kaolin particles can be produced by first dispersing the crude kaolin in a convenient manner well known in the art, then separating the dispersion using one or more of degritting, floatation, ozonation, high speed centrifugation, selective flocculation, magnetic separation, and then refining in any suitable manner to provide the high brightness and/or fine kaolin particles. The methods disclosed herein can further include processing the rejects from the separation and/or refining steps to obtain the kaolin particles disclosed herein.

In some embodiments, the method can include forming a kaolin slurry by combining the kaolin crude with water, and optionally a dispersant. The dispersant can be added to the slurry to provide additional fluidity to facilitate the subsequent (including degritting) processes. The dispersant can be an organic dispersant or inorganic dispersant. Suitable inorganic dispersants include phosphate and silicate salts. Examples of phosphate salts include inorganic polyphosphates and pyrophosphates (which are actually a type of polyphosphate), sodium hexametaphosphate (SHMP), sodium tripolyphosphate (STPP), tetrasodium pyrophosphate (TSPP), and sodium silicate. Suitable organic dispersants can include ammonia-based dispersants, sulfonate dispersants, carboxylic acid dispersants, and polymeric dispersants (such as polyacrylate dispersants), as well as other organic dispersants conventionally employed in kaolin particle processing. The amount of dispersant used in the slurry can be from 0.01% to 1% based on the weight of kaolin crude.

The method for refining the kaolin crude can include degritting the slurry. Degritting can be performed in any conventional manner using one or more of sieves, sandboxes, gravity settling, or hydrocyclones. Either wet or dry degritting may be employed. In some embodiments, degritting can be carried out by combining the kaolin crude with water and passing the slurried mixture through a sieve, such as a 325 mesh sieve or a 200 mesh sieve. The resulting degritted kaolin crude may be composed largely of kaolin particles that usually have a wide range of sizes ranging from slimes (finer than 0.3 microns) up to about 15 microns.

After degritting, the resulting degritted kaolin can be subjected to flotation, selective flocculation, and/or magnetic separation. Flotation, selective flocculation, and/or magnetic separation serve to reduce the titania content of the kaolin crude.

Selective flocculation can be carried out in any conventional manner. In selective flocculation, charged inorganic or organic molecules are used to selectively flocculate minerals from each other based on difference in mineral species. In some embodiments, the flocculation polymer can include a high molecular weight anionic polymer having a molecular weight greater than 100,000 Da. The high molecular weight anionic polymer can be selected from an anionic polyacrylamide, an acrylate acrylamide copolymer, an acrylic acrylamide copolymer, and combinations thereof. The selective flocculation process is such that exclusively gray crudes, or crude blends of various colored kaolin clays can be processed to obtain premium brightness kaolin products.

The method can further include conditioning the kaolin suspension prior to adding the flocculation polymer thereto. The conditioning step can include the addition of various conditioning chemicals to facilitate polymer absorption (a high molecular weight, anionic polymer) onto the impurities in the kaolin clay during the selective flocculation step. Other suitable conditioning steps can include allowing the kaolin suspension to age for a period of at least thirty minutes, adjusting the pH of the kaolin suspension prior to allowing the suspension to age, adding sodium salt to the kaolin suspension after providing the dispersed aqueous suspension, or mechanically agitating the kaolin suspension during the aging.

Flotation can be performed in any conventional manner including wet flotation, ultraflotation, froth flotation, or TREP flotation (titania removal and extraction process). General methods of flotation are described in Mathur, S., “Kaolin Flotation”, Journal of Colloid and Interface Science, 256, pp. 153-158, 2002, which is hereby incorporated by reference in this regard.

The kaolin can be centrifuged prior to flotation, selective flocculation, and/or magnetic separation to control the particle size distribution such that subsequent high speed centrifuge operation results in the desired particle size distribution. Although not wishing to be bound by any theory, it is believed that the usage of high-speed centrifuge can also results in removal of some impurities, such as coloring impurities and thus increasing brightness of the clay. Centrifugation can be conducted in a single step or multiple steps. In some embodiments, the method can include a high-speed centrifugation treatment in which the centrifuge can operate at “g” forces from above 1,000 to 10,000. For example, the high-speed centrifugation treatment can operate at “g” forces from 2,000 to 7,500 or from 2,500 to 5,000. Examples of centrifuges that can be used in the methods described herein can include Bird solid bowl machines, high speed centrifuges, horizontal three-phase centrifuges, and the like.

The kaolin undergoing processing can be optionally subjected to ozonation or treated with hydrogen peroxide or sodium hypochlorite. Ozonation involves, using ozone, to bleach components, such as organic discolorants, that may be present. The ozone acts not only to destroy substantial portions of discoloring organics, but also destroys by oxidation the organic dispersant, if such a compound is present. However, the ozone does not destroy inorganic dispersants. Ozone, hydrogen peroxide or sodium hypochlorite can be utilized for removing any organic impurities associated with the crude kaolin or introduced during clay processing steps.

Ozonation can be carried out at a suitable dosage level, such as from 0.1 to 20 pounds of ozone per ton of kaolin. In some embodiments, ozonation can be carried out at a dosage level from 0.5 to 10 pounds of ozone per ton of kaolin. The ozone can be applied as a stream of bubbles which can be passed upwardly through the slurry. This can be a batch process or a continuous process in which the ozone bubbles pass counter current to a flow of the slurry in a pipe or other conduit, such as mixed and packed column.

The kaolin obtained from the one or more of degritting, floatation, ozonation, high speed centrifugation, selective flocculation, and magnetic separation can be further refined. For example, the kaolin can be further refined using a method including at least one of flocculation, bleaching, filtering, drying, blending, and pulverizing to provide the ultrafine hydrous kaolin. Flocculation involves separating minerals of one species from minerals of the same species, e.g., the separation of ultrafine kaolin particles from fine or coarse kaolin particles. Flocculation can be effected using an ionic material, such as an acid. In some embodiments, sulfuric acid in combination with alum can be used for flocculation.

The methods described herein can include bleaching the kaolin particles. Generally, bleaching includes increasing the brightness of the kaolin. Bleaching can include contacting the kaolin with a suitable amount of one or more of hydrosulfite (dithionite) salts, potassium permanganate, oxygen gas, alkali bichromates, alkali chlorates, alkali chlorites, ammonium persulfate, soluble peroxides such as sodium and hydrogen peroxide, or sodium hypochlorite. Filtration can be employed to increase the solids content of the kaolin sample (e.g. such as to greater than 50 wt %) after bleaching. Increasing the solids content in some instances can improve the efficiency of a subsequent spray drying operation. Filtration can be carried out using rotary drum vacuum filters.

The filter cake of the kaolin particles can be re-dispersed in the presence of one or more of the dispersants described herein. The dispersant chosen can affect various properties of the kaolin clay product formed, such as the brightness and the alkali (e.g. sodium) level, among other properties.

Drying, such as spray drying, the kaolin can be performed to reduce the moisture level of the kaolin. Drying the kaolin may facilitate subsequent pulverization of the kaolin. The kaolin can be dried by spray drying, flash drying, rotary drying, or a combination thereof. The heated air stream can have a temperature of from about 600° F. to about 1,000° F. In some embodiments, after drying the kaolin can have a moisture level of less than 1.5% by weight, less than 1% by weight, or less than 0.5% by weight.

In the present case, calcination is carried out at a temperature and for a duration of time sufficient to convert hydrous kaolin to spinel and then a targeted percentage of the spinel to mullite. Calcination temperature and residence time are a function of the process configuration utilized. The upper temperature limit for the calcination step is determined by the amount of mullite desired in the finished crystalline lattice. It is known that calcination of kaolins at temperatures of 1400° C. to 1600° C. converts substantially all the kaolin to mullite.

The methods described herein can include pulverizing the kaolin particles. In some embodiments, the kaolin particles can be pulverized during or after spray drying and/or during or after calcination. For example, rotating paddles and baffles present in the air dryer/oven can beat and flop the airborne kaolin around within the dryer/oven such that, as the kaolin dries/calcines, it becomes pulverized. Pulverization may break up agglomerates formed during drying, calcination, and other process acts. In some embodiments, the kaolin particles can be pulverized at least once.

The pulverized kaolin particles, once they are sufficiently dried/calcined and sufficiently sized, become entrained in the air stream and can be removed from the dryer/oven for subsequent separation. In some embodiments, the individual kaolin particles leaving the dryer/oven may be separated into respective product streams by particle size via one or more conventional classification techniques. Such techniques can include an air cyclone or an air classifier.

The kaolin rejects obtained from the one or more of degritting, floatation, ozonation, high speed centrifugation, selective flocculation, magnetic separation, bleaching, spray drying, and/or calcination can be used to prepare the kaolin particles provided herein. For example, two or more of the kaolin rejects can be optionally combined to produce a waste kaolin slurry. In some embodiments, the kaolin compositions disclosed herein can be obtained from a spray dried or calcined waste stream in the process of producing high brightness and/or fine kaolin particles.

In some embodiments, the waste stream can be obtained from one or more of refining steps. In these embodiments, the concentration of the waste kaolin slurry can be reduced by filtration, frothing, sedimentation, or flocculation. This concentration step permits the efficient handling and further processing of the kaolin particles. In some embodiments, the waste kaolin slurry can be concentrated to produce a suspension having a solids content of at least 50 wt %, at least 55 wt %, at least 60 wt %, at least 65 wt %, or at least 70 wt %.

After the waste kaolin suspension is formed, the kaolin particles can optionally be washed to remove excess salts accumulated in earlier processing. For example, the suspension can be dispersed, diluted, screened, re-flocculated, and filter. The suspension can be further washed on the filters by using sprays or multiple filtration. Optionally, the kaolin suspension can be further separated using one or more of degritting, floatation, ozonation, high speed centrifugation, selective flocculation, magnetic separation.

After washing, the filter cake can be filtered, dried, and/or calcined as described herein.

Method of Use

The kaolin particles disclosed herein can be used in any application wherein kaolin can be used. For example, kaolin particles can be used in papers, plastics, rubbers, coatings, chemicals industries, ceramics, concrete, asphalt-aggregate mixtures, asphalt roofing compounds, catalysts, sealants, and adhesives. In some embodiments, the kaolin particles can be used in coating compositions. The coating compositions can be used in several applications, including blasting media, papers for example as reinforcing extenders or functional component in paper coating, paints, sealants, adhesives, films, floor coatings, high build coatings, block filler concrete coatings with textured finish and other concrete coatings, deck coatings, rubber liners coatings, and other coatings where abrasion resistance is required.

In some embodiments, the kaolin particles can be used as a blasting media in a sandblasting process. For example, the kaolin particles can be used to remove a paint or rust or to otherwise prepare a surface to receive a new coating.

In some embodiments, the kaolin particles can be formulated into paint. For example, the kaolin particles can be formulated into paints to act as an extender, enhance the dry film properties of primers and undercoats, increase scrub resistance, or improve slip resistance. In some embodiments, the kaolin particles can be formulated as rubber. In some embodiments, the kaolin particles can be formulated as sealants and adhesives, for example to modify their rheological properties. In some embodiments, the kaolin particles can be used as pigments.

Other specific examples of formulations that can include the kaolin particles described herein include, but are not limited to, abrasives, roofing granules, filtration products, hard coatings, shot blast media, tumbling media, brake linings, anti-slip and wear resistant coatings, synthetic bone, dental compositions, retro-reflective sheeting, and laminate composite structures.

Articles comprising the kaolin compositions disclosed herein can include a PVC pipe, a concrete, a brick, a mortar, an asphalt composition, a granulated asphaltic cap sheet, a carpet, a granule, a pavement, a floor tile, a deck, a sport surface, an exterior insulation and finish system (EIFS), a spray polyurethane foam surface, a thermoplastic polyolefin surface, an ethylene-propylene diene monomer (EPDM) surface, a modified bitumen surface, a roof, a wall, a storage tank, an expanded polystyrene (EPS) board, a wood, a plywood, an oriented strand board (OSB), a paper, a metal sheathing, an interior sheathing or exterior sheathing (including gypsum board or cement board), a siding, or another coating surface (in the case of recoating applications).

The coating compositions comprising the kaolin particles can be applied to a surface by any suitable coating technique, including spraying, rolling, brushing, or spreading. The composition can be applied in a single coat, or in multiple sequential coats (e.g., in two coats or in three coats) as required for a particular application. Generally, the coating composition is allowed to dry under ambient conditions.

By way of non-limiting illustration, examples of certain embodiments of the present disclosure are given below.

### EXAMPLES

The following examples are put forth so as to provide those of ordinary skill in the art with a complete disclosure and description of how the compositions and/or methods claimed herein are made and evaluated, and are intended to be purely exemplary and are not intended to limit the scope of the disclosure. Unless indicated otherwise, parts are parts by weight, temperature is in ° C. or is at ambient temperature, and pressure is at or near atmospheric.

### Example 1: Preparation of a Coarse Particle Size Kaolin Stream

In this example, crude kaolin was refined using one or more of the following processes: blunging, degritting, centrifuging, selective flocculation, and ozoning. The refined kaolin was then spray dried, pulverized, and calcined. The calcined kaolin particles were classified using an air classifier to separate the particles into a fine kaolin particle stream and the inventive kaolin particle stream. Tables 3A-3C summarize the properties of the inventive kaolin stream.

TABLE 3A
Physical properties of coarse kaolin streams.

| | Sample 1 | Sample 2 | Sample 3 | Sample 4 | Sample 5 | Sample 6 | Sample 7 |
|---|---|---|---|---|---|---|---|
| D10 (μm) | 1.97 | 2.24 | 2.20 | 2.13 | 2.12 | 2.61 | 2.8 |
| D50 (μm) | 8.67 | 12.9 | 18.9 | 13.2 | 13.3 | 32.9 | 34.7 |
| D90 (μm) | 54.1 | 65.7 | 67.9 | 67.2 | 63.8 | 64.2 | 64.9 |
| +400 mesh (%, total | 52.0 | 45.1 | 51.9 | 56.0 | 49.0 | 57.5 | 58.4 |
| superhard content)⁺ | | | | | | | |
| Loose bulk density | 37.4 | 35.5 | 41.8 | 42.5 | 42.9 | 42.9 | 52.6 |
| (lb/ft³) | | | | | | | |
| Tap bulk density | 62.4 | 58 | 66.1 | 68 | 66.8 | 66.1 | 84.9 |
| (lb/ft³) | | | | | | | |
| GEB Brightness | 83 | 85.7 | 83.8 | 82.8 | 84.5 | 84.3 | 78.4 |
| Mullite Index | 36.3 | 27.5 | 33.4 | 36.0 | 33.9 | 34.7 | 43.7 |
| Oil absorption | 28 | 23.4 | 23.4 | 24.9 | 23.4 | 23.4 | 18.7 |
| Crystalline silica, (%) | <0.1 | <0.1 | <0.1 | <0.1 | <0.1 | <0.1 | <0.1 |

⁺the total superhard content is the kaolin particle fraction having an attrition rate of less than 3%.
*Crystalline silica includes quartz, crystobalite, and tridimite.

TABLE 3B
XRF Results - VF (volatile free) basis, pressed pellet

| Sample | | | | | | | | | | |
|---|---|---|---|---|---|---|---|---|---|---|
| ID | % SiO₂ | % Al₂O₃ | % Na₂O | % K₂O | % TiO₂ | % Fe₂O₃ | % CaO | % MgO | % P₂O₅ | Sum |
| 1 | 51.7 | 44.9 | 0.25 | 0.13 | 1.45 | 0.43 | 0.01 | 0.02 | 0.07 | 99.0 |

TABLE 3C
XRF Results - back-calculated to “as received” basis using % LOI

| Sample | | | | | | | | | | |
|---|---|---|---|---|---|---|---|---|---|---|
| ID | % SiO₂ | % Al₂O₃ | % Na₂O | % K₂O | % TiO₂ | % Fe₂O₃ | % CaO | % MgO | % P₂O₅ | % LOI |
| 1 | 51.6 | 44.7 | 0.25 | 0.13 | 1.44 | 0.43 | 0.01 | 0.02 | 0.07 | 0.31 |

Attrition Test: the coarse kaolin pigments were subject to air jet attrition testing using the ASTM D5757 method. Table 4 summarizes the attrition properties of the coarse kaolin and control.

TABLE 4
Attrition properties of coarse kaolin particles.

| | Sample | | | | | | |
|---|---|---|---|---|---|---|---|
| | | | | | | | Control |
| | 8 | 9 | 10 | 11 | 12 | Control | (Standard) |
| Attrition | 0.085 | 1.765 | 0.17 | 0.05 | 0.95 | 4.1 | 3 |
| Rate | | | | | | | |
| Air Jet | 0.64 | 12.78 | 1.56 | 0.6 | 9.4 | no data | no data |
| Index | | | | | | | |
| % | 96.64 | 82.58 | 81.42 | 90.6 | 92.8 | no data | no data |
| Recovery | | | | | | | |

Paint Formulation: the coarse kaolin particles were evaluated in a high-build deck coating paint (Table 5). About 10% by volume of the fine filler and ground silica were replaced with a bimodal coarse kaolin as described herein.

TABLE 5
Paint formulations

| | | 2 (10% Minex/Silica |
|---|---|---|
| Example | 1 | replacement) |

Charge the latex to the grind pot

| | | |
|---|---|---|
| Acronal 4750(50%) | 260.00 | 260.00 |
| Acronal 4247(50%) | | |

With Stirring add the following

| | | |
|---|---|---|
| PG | 7.50 | 7.50 |
| Dispex CX 4320(25%) | 7.25 | 7.25 |
| FoamStar ST2420 | 2.30 | 2.30 |
| Hydropalat WE3320 | 1.15 | 1.15 |
| AMP-95 | 0.60 | 0.60 |
| Attagel 50 | 0.55 | 0.55 |
| Minex 2 | 210.00 | 185.00 |
| Bimodal Kaolin | 0.00 | 25.00 |
| Tipure R-706 | 5.75 | 5.75 |
| WG 325 Mica | 15.00 | 15.00 |

Grind at high speed (~1200 RPM) for 15 min. Reduce speed and add the
following

| | | |
|---|---|---|
| F-65 Sand <PS> ~300 um) | 65.00 | 65.00 |
| Siliosil 125 | 35.00 | 32.50 |
| Mix for 5 minutes then add the following | | |
| Water | 45.00 | 45.00 |
| Natrosol 250 HBR | 0.50 | 0.50 |
| Optifilm 400 | 5.00 | 5.00 |
| Velate 368 | 7.00 | 7.00 |
| Rheovis PU 1251 | 2.25 | 2.25 |
| Rheovis PE 1331 | 7.80 | 7.80 |
| Total base | 677.65 | 675.15 |

Pour into a tared container (500 cc)
Place on overhead mixer with 2″ paddle the add
Rescale the amount of colorant needed

| | | |
|---|---|---|
| Colorant CL | 32.10 | 32.10 |
| Colorant FL | 5.20 | 5.20 |
| Colorant IL | 16.40 | 16.40 |

TABLE 6
Properties of paint formulations from Table 5.

| | | |
|---|---|---|
| Example | 1 | 2 |

Dirt Resistance

| | | |
|---|---|---|
| ΔY | 3.4 | 2.7 |
| Conical Mandrel | No Cracking | No Cracking |

Tabor(750 cycles, CS17 wheels, 1 Kg)

| | | |
|---|---|---|
| Wear Index | 0.08 | 0.16 |

Summary: replacing ground silica and some of the finer fill Minex maintains acceptable performance with some improvement in dirt resistance.

Flat Paint Formulation: the coarse kaolin particles formulated as a flat paint formulation. The properties of the flat paint formulation is shown in Table 7.

TABLE 7
Properties of flat paint formulations

| | Control (Mattex | Example 3 |
|---|---|---|
| Properties | Pro CTL) | (#MKI2015-0033) |
| Kui | 88 | 91 |
| KUe | 104 | 109 |
| Contrast Ratio 3 mils: | 98.4 | 97.5 |
| Brightness: | 88.10 | 87.63 |
| Whiteness: | 80.77 | 81.78 |
| Yellowness: | 2.50 | 1.97 |
| L* | 96.05 | 95.68 |
| a* | −0.71 | −0.58 |
| b* | 1.93 | 1.67 |
| Gloss @ 20 deg: | 1.4 | 1.5 |
| Gloss @ 60 deg: | 2.5 | 3.6 |
| Sheen @ 85 deg: | 2.6 | 1.2 |
| Tint Stregth: Xrite | 100.1 | 86.9 |
| Surface Roughness: | | |
| Tactile & Visual | | |
| Visual Comparison: | CTL | Darker tone |
| Versus CTL | | compared to Ctl |
| Film Coarseness/Grit, | Low | Very High |
| visual & tactile: | | |
| Scrub Resistance: 1 Hr. | Mattex | |
| Air Cure then 1.5 Hr. 50 C. | Pro CTL | |
| cure | | |
| Sample 1 | 1860 | 3949 |
| Sample 2 | 2210 | 4000 |
| Average | 2035 | 3975 |
| % Change compared to | | 95.3 |
| CTL | | |
| Ability to Filter: | OK | OK |

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A kaolin composition comprising kaolin particles having a GE brightness of at least 78 and a particle size distribution wherein at least 50% by weight of the kaolin particles have an equivalent size diameter (e.s.d.) of 30 μm or greater, as determined by a Microtrac Model S3500 Particle Size Analyzer.

2. The kaolin composition according to claim 1, wherein the GE brightness of the kaolin particles is from 78 to 89.

3. The kaolin composition according to claim 1, wherein at least 50% by weight of the kaolin particles have an e.s.d. of from 30 μm to 200 μm.

4. The kaolin composition according to claim 1, wherein at least 90% by weight of the kaolin particles have an e.s.d. of 75 μm or less.

5. The kaolin composition according to claim 1, wherein the kaolin composition has a bimodal particle distribution.

6. The kaolin composition according to claim 1, wherein the kaolin particles comprise less than 0.1% by weight crystalline silica content.

7. The kaolin composition according to claim 1, wherein the kaolin particles have an oil absorption of from 17 to 25 lbs oil/100 lbs kaolin.

8. The kaolin composition according to claim 1, wherein the kaolin particles have an average surface area of 10 m²/g or less.

9. The kaolin composition according to claim 1, wherein the kaolin particles comprise calcined kaolin.

10. The kaolin composition according to claim 1, wherein a +400 mesh fraction of the kaolin particles has an attrition rate of less than 3%, as determined by ASTM D5757.

11. The kaolin composition according to claim 1, wherein the kaolin particles have a mullite index of from 25 to 62.

12. A coating comprising the kaolin composition according to claim 1.

13. A kaolin composition comprising kaolin particles having a bimodal particle distribution, wherein the kaolin particles comprise a first fraction having an average particle diameter of from 3 μm to 8 μm and a second fraction having an average particle diameter of from 30 μm to 50 μm.

14. The kaolin composition according to claim 13, wherein the weight ratio between the first fraction and the second fraction is from 1:4 to 2:1.

15. The kaolin composition according to claim 13, wherein the kaolin particles have a GE brightness of at least 78.

16. The kaolin composition according to claim 13, wherein the kaolin particles have an average surface area of 10 m²/g or less.

17. The kaolin composition according to claim 13, wherein the kaolin composition comprises calcined kaolin.

18. A coating comprising the kaolin composition according to claim 13.

19. A kaolin composition comprising kaolin particles having a crystalline silica content of 0.1% by weight or less, and a particle size distribution wherein at least 50% by weight of the kaolin particles have an equivalent size diameter (e.s.d.) of 15 μm or greater, as determined by a Microtrac Model S3500 Particle Size Analyzer.

20. The kaolin composition according to claim 19, wherein the kaolin particles have a GE brightness of 78 or greater.

21. The kaolin composition according to claim 19, wherein at least 50% by weight of the kaolin particles have an e.s.d. of from 30 μm to 200 μm.

22. The kaolin composition according to claim 19, wherein the kaolin composition has a bimodal particle distribution.

23. The kaolin composition according to claim 19, wherein the kaolin particles comprise calcined kaolin.
